(19) United States
(12) Patent Application Publication
(10) Pub. No.: US 2021/0079175 A1
(43) Pub. Date: Mar. 18, 2021

(54) METHOD FOR PRODUCING RUBBER WET MASTERBATCH, METHOD FOR PRODUCING RUBBER MEMBER FOR PNEUMATIC TIRES, AND METHOD FOR PRODUCING PNEUMATIC TIRE

(71) Applicant: TOYO TIRE CORPORATION, Itami-shi, Hyogo (JP)

(72) Inventor: Kenji Nomura, Itami-shi (JP)

(73) Assignee: TOYO TIRE CORPORATION, Itami-shi, Hyogo (JP)

(21) Appl. No.: 16/771,949

(22) PCT Filed: Oct. 29, 2018
(86) PCT No.: PCT/JP2018/040103

§ 371 Date: Jun. 11, 2020

(30) Foreign Application Priority Data
Dec. 14, 2017 (JP) 2017-239194
Dec. 14, 2017 (JP) 2017-239195

(51) Int. Cl. C08J 3/22; C08K 3/04; C08K 3/36; C08K 3/22; C08L 7/02; C08L 21/02; B60C 1/00

(52) U.S. Cl. CPC C08J 3/22; C08K 3/04; C08K 3/36; C08K 2003/2227; C08L 7/02; C08L 21/02; B60C 1/0016; C08K 3/22

(57) ABSTRACT

A method for producing a rubber wet masterbatch comprises step (i) of producing a slurry solution by dispersing carbon black in a dispersing solvent in the presence of an inorganic filler, step (ii) of producing a slurry-containing rubber latex solution by mixing the slurry solution with a rubber latex solution, and step (iii) of producing a rubber wet masterbatch by solidifying and drying the slurry-containing rubber latex solution. The inorganic filler has a Mohs hardness of 5 or more, and in the step (i), the amount of the inorganic filler added is less than 50% by mass where the amount of the carbon black added is 100% by mass.

### TECHNICAL FIELD

The present invention relates to a method for producing a rubber wet masterbatch obtained using at least carbon black, an inorganic filler, a dispersing solvent, and a rubber latex solution as raw materials, a method for producing a rubber member for pneumatic tires, and a method for producing a pneumatic tire.

### BACKGROUND ART

Conventionally, in the rubber industry, it has been known to use a rubber wet masterbatch in order to improve the processability in producing a rubber composition containing carbon black and the dispersibility of carbon black. This involves mixing carbon black with a dispersing solvent in a fixed ratio beforehand; mixing, in a liquid phase, a rubber latex solution with a carbon black-containing slurry solution prepared by dispersing the carbon black in the dispersing solvent by a mechanical force; and then collecting and drying a solidified product yielded by the addition of a solidifier such as an acid. In the case of using a rubber wet masterbatch, a rubber composition superior in the dispersibility of carbon black and superior in rubber properties such as processability and reinforceability is obtained as compared to the case of using a rubber dry masterbatch obtained by mixing carbon black with rubber in a solid phase. By using such a rubber composition as a raw material, for example, a rubber product, such as a pneumatic tire, having reduced rolling resistance and being superior in fatigue resistance and reinforceability can be produced.

In the technological field of producing a rubber wet masterbatch, there are many examples of reports particularly investigating the process of producing a carbon black-containing slurry solution.

For example, Patent Document 1 cited below discloses a method for producing a zinc flower-containing rubber wet masterbatch by dispersing zinc flower and carbon black simultaneously by using a highly shearing mixer. Patent Document 2 cited below discloses a method for producing a rubber composition involving a premixing step of wet-mixing carbon black and a smectite-based powder in the form of an aqueous slurry.

Further, Patent Document 3 cited below discloses a method for producing a rubber wet masterbatch, the method involving a step of preparing a slurry solution by adding 100 g of silica where the amount of carbon black added is 120 g (83% by mass of silica where the amount of carbon black added is 100% by mass), followed by aqueous dispersion using a highly shearing mixer in the absence of a surfactant.

### PRIOR ART DOCUMENTS

### Patent Documents

Patent Document 1: JP-A-2006-213791

Patent Document 2: JP-A-2002-256109

Patent Document 3: JP-A-2006-219593

### SUMMARY OF THE INVENTION

### Problems to be Solved by the Invention

However, as a result of intensive studies by the present inventor, it has been found that the prior art technologies have a room for further improvement in terms of improving the dispersibility of carbon black. Specifically, in Patent Document 1 described above, zinc flower is blended when a carbon black-containing slurry solution is produced, but the zinc flower does not contribute to improving the dispersibility of the carbon black. Similarly, the smectite-based powder in Patent Document 2 also does not contribute to improving the dispersibility of carbon black. In Patent Document 3 cited above, silica is added when producing a carbon black-containing slurry solution, but the amount of silica added for the amount of carbon black added is very large, and it has been revealed that a slurry solution superior in dispersibility of carbon black or a rubber wet masterbatch prepared using the slurry solution as a raw material cannot be produced.

The present invention has been made in view of the above circumstances, and an object of the present invention is to provide a method for producing a rubber wet masterbatch superior in the dispersibility of carbon black.

Another object of the present invention is to provide a method for producing a rubber member being superior in the dispersibility of carbon black and also superior in ability to achieve reduced heat generation and reinforceability, and a method for producing a pneumatic tire including the rubber member.

### Means for Solving the Problems

The present invention relates to a method for producing a rubber wet masterbatch including step (i) of producing a slurry solution by dispersing carbon black in a dispersing solvent in the presence of an inorganic filler, step (ii) of producing a slurry-containing rubber latex solution by mixing the slurry solution with a rubber latex solution, and step (iii) of producing a rubber wet masterbatch by solidifying and drying the slurry-containing rubber latex solution, wherein the inorganic filler has a Mohs hardness of 5 or more, and in the step (i), the amount of the inorganic filler added is less than 50% by mass where the amount of the carbon black added is 100% by mass.

In the method for producing a rubber wet masterbatch according to the present invention, in the step (i) of producing a slurry solution by dispersing carbon black in a dispersing solvent, the carbon black is dispersed in the dispersing solvent in the presence of an inorganic filler having a Mohs hardness of 5 or more. The inorganic filler having a Mohs hardness of 5 or more is harder than carbon black, so that when carbon black is dispersed in a dispersing solvent, the carbon black is dispersed while being crushed by the inorganic filler. As a result, the dispersibility of the carbon black in the slurry solution containing the inorganic filler and the carbon black is greatly increased, so that the dispersibility of the carbon black in the rubber wet masterbatch finally produced is improved even through the steps (ii) and (iii).

It is noted that in the present invention, in the step (i), the amount of the inorganic filler added is required to be less than 50% by mass where the amount of the carbon black added is 100% by mass. Thanks to adjusting the amount of the inorganic filler added to less than 50% by mass where the amount of the carbon black added is 100% by mass, the inorganic filler enters aggregates of the carbon black in the slurry solution, so that a slurry solution in which the carbon black is uniformly dispersed can be produced. On the other hand, the condition that the amount of the inorganic filler added is greater than 50% by mass where the amount of the carbon black added is 100% by mass is undesirable because an excessive amount of the inorganic filler deteriorates the dispersibility of the carbon black instead, and furthermore, the dispersibility of the inorganic filler itself also deteriorates.

In the above production method, it is preferable that the step (i) be a step of dispersing the carbon black in the dispersing solvent using a highly shearing mixer. Thanks to the use of the highly shearing mixer in dispersing the carbon black in the dispersing solvent, the effect of the inorganic filler to crush carbon black is further increased, so that the dispersibility of the carbon black in the carbon black-containing slurry solution and in the rubber wet masterbatch finally produced is further improved.

Another aspect of the present invention relates to a method for producing a rubber member for pneumatic tires obtained by vulcanizing a rubber composition containing at least a rubber wet masterbatch, wherein the rubber wet masterbatch is produced through the following steps (i) to (iii);

step (i): a step of producing a slurry solution by dispersing carbon black in a dispersing solvent in the presence of an inorganic filler

step (ii): a step of producing a slurry-containing rubber latex solution by mixing the slurry solution with a rubber latex solution

step (iii): a step of producing a rubber wet masterbatch by solidifying and drying the slurry-containing rubber latex solution,

wherein the inorganic filler has a Mohs hardness of 5 or more, and in the step (i), the amount of the inorganic filler added is less than 50% by mass where the amount of the carbon black added is 100% by mass.

The method of producing a rubber member for pneumatic tires according to the present invention is characterized by the process of producing a rubber wet masterbatch to be used as a raw material, and specifically, the rubber wet masterbatch is produced through the following (i) to (iii). First, in the step (i) of producing a slurry solution by dispersing carbon black in a dispersing solvent, the carbon black is dispersed in the dispersing solvent in the presence of an inorganic filler having a Mohs hardness of 5 or more. The inorganic filler having a Mohs hardness of 5 or more is harder than carbon black, so that when carbon black is dispersed in a dispersing solvent, the carbon black is dispersed while being crushed by the inorganic filler. As a result, the dispersibility of the carbon black in the slurry solution containing the inorganic filler and the carbon black is greatly increased, so that the dispersibility of the carbon black in the rubber wet masterbatch finally produced is improved even through the steps (ii) and (iii). Thanks to the superior dispersibility of the carbon black in the rubber wet masterbatch, a rubber member prepared by vulcanizing the rubber composition containing the rubber wet masterbatch is similarly superior in the dispersibility of carbon black. As a result, the rubber member is superior in ability to achieve reduced heat generation and reinforceability.

It is noted that in the present invention, in the step (i), the amount of the inorganic filler added is required to be less than 50% by mass where the amount of the carbon black added is 100% by mass. Thanks to adjusting the amount of the inorganic filler added to less than 50% by mass where the amount of the carbon black added is 100% by mass, the inorganic filler enters aggregates of the carbon black in the slurry solution, so that a slurry solution in which the carbon black is uniformly dispersed can be produced. On the other hand, the condition that the amount of the inorganic filler added is greater than 50% by mass where the amount of the carbon black added is 100% by mass is undesirable because an excessive amount of the inorganic filler deteriorates the dispersibility of the carbon black instead, and furthermore, the dispersibility of the inorganic filler itself also deteriorates.

In the above production method, it is preferable that the step (i) be a step of dispersing the carbon black in the dispersing solvent using a highly shearing mixer. Thanks to the use of the highly shearing mixer in dispersing the carbon black in the dispersing solvent, the effect of the inorganic filler to crush carbon black is further increased, so that the dispersibility of the carbon black in the carbon black-containing slurry solution and in the rubber wet masterbatch finally produced is further improved. Accordingly, the dispersibility of the carbon black in the rubber member is further improved, so that the ability to achieve reduced heat generation and the reinforceability of the rubber member are also further improved.

In the above production method, it is preferable that the rubber member be a tread member. Among the rubber members constituting a pneumatic tire, the tread member is particularly required to have ability to achieve reduced heat generation and reinforceability, but a tread member produced using a rubber wet masterbatch produced through the above-described production process as a raw material is superior in the dispersibility of carbon black and therefore is improved in ability to achieve reduced heat generation and reinforceability.

The present invention also relates to a method for producing a pneumatic tire including a rubber member, wherein the rubber member is produced by any one of the above-described methods. Since the rubber member is superior in the dispersibility of carbon black, the ability to achieve reduced heat generation and the reinforceability of a pneumatic tire including that member are also improved.

### MODE FOR CARRYING OUT THE INVENTION

The present invention relates to a method for producing a rubber wet masterbatch obtained using at least carbon black, an inorganic filler, a dispersing solvent, and a rubber latex solution as raw materials, a method for producing a rubber member for pneumatic tires, and a method for producing a pneumatic tire.

In the present invention, as the carbon black, for example, conductive carbon black such as acetylene black and Ketjen black as well as carbon black to be used in the ordinary rubber industry such as SAF, ISAF, HAF, FEF, and GPF can be used. The carbon black may be granulated carbon black granulated in consideration of its handleability in the ordinary rubber industry or non-granulated carbon black. The loading of the carbon black is preferably 10 to 80 parts by mass, and more preferably 20 to 60 parts by mass where the total amount of the rubber component in the rubber composition obtained from the rubber wet masterbatch as a raw material is 100 parts by mass.

As the inorganic filler, one having a Mohs hardness of 5 or more is used. The Mohs hardness is determined by preparing ten standard minerals corresponding to integer values of from 1 to 10 and sequentially scratching the target substance with the standard minerals to determine the hardness. The higher the value, the harder the target substance is. The standard minerals are as follows: talc (Mohs hardness 1), gypsum (Mohs hardness 2), calcite (Mohs hardness 3), fluorite (Mohs hardness 4), apatite (Mohs hardness 5), orthoclase (Mohs hardness 6), quartz (Mohs hardness 7), topaz (Mohs hardness 8), corundum (Mohs hardness 9), and diamond (Mohs hardness 10). Examples of the inorganic filler having a Mohs hardness of 5 or more include silica (Mohs hardness (7)) and alumina (Mohs hardness 9). The Mohs hardness of silica was determined based on the Mohs hardness of silicon dioxide that constitutes silica. The loading of the inorganic filler is preferably 1 to 40 parts by mass, and more preferably 3 to 30 parts by mass where the total amount of the rubber component in the rubber composition obtained from the rubber wet masterbatch as a raw material is 100 parts by mass. The amount of the inorganic filler added relative to the amount of the carbon black added in the step (i) will be described below.

As silica, for example, wet-process silica and dry-process silica can be used. Among them, it is preferable to use wet-process silica containing hydrated silicic acid as a main component.

It is particularly preferable to use water as the dispersing solvent, but for example, water containing an organic solvent may be used.

As the rubber latex solution, a natural rubber latex solution and a synthetic rubber latex solution may be used.

The natural rubber latex solution is a natural product produced by metabolic effect of plants, and is in particular preferably a natural-rubber/water system solution, in which a dispersing solvent is water. As to the natural rubber latex solution, a concentrated latex, a fresh latex called field latex, and other latexes are usable without being distinguished from each other. The synthetic rubber latex solution is, for example, a latex solution of styrene-butadiene rubber, butadiene rubber, nitrile rubber or chloroprene rubber produced by emulsion polymerization.

### First Embodiment

Hereinafter, a method for producing a rubber wet masterbatch according to the present invention will be described. The production method comprises step (i) of producing a slurry solution by dispersing carbon black in a dispersing solvent in the presence of an inorganic filler, step (ii) of producing a slurry-containing rubber latex solution by mixing the slurry solution with a rubber latex solution, and step (iii) of producing a rubber wet masterbatch by solidifying and drying the slurry-containing rubber latex solution, wherein the inorganic filler has a Mohs hardness of 5 or more, and in the step (i), the amount of the inorganic filler added is less than 50% by mass where the amount of the carbon black added is 100% by mass.

### (1) Step (i)

In step (i), carbon black is dispersed in a dispersing solvent in the presence of an inorganic filler, and thus a slurry solution containing the inorganic filler and the carbon black is produced. As to the timing when the carbon black is added to the dispersing solvent, the carbon black may be added after the inorganic filler is added to the dispersing solvent in advance and, if necessary, the inorganic filler is dispersed in the dispersing solvent, or alternatively, the inorganic filler may be added after the carbon black is added to the dispersing solvent in advance. Alternatively, the carbon black and the inorganic filler may be added simultaneously to the dispersing solvent. In the step (i), the concentration of the carbon black in the dispersing solvent may be appropriately adjusted in consideration of workability and the like, but it is preferably about 2 to 15% by mass in consideration of the dispersibility of the carbon black.

In the step (i), the amount of the inorganic filler added relative to the amount of the carbon black added is adjusted to less than 50% by mass. In order to produce a slurry solution in which carbon black is uniformly dispersed, it is more preferable to adjust the amount of the inorganic filler added relative to the amount of the carbon black added to be less than 45% by mass. When the amount of the inorganic filler added relative to the amount of the carbon black added is extremely small, the crush of the carbon black by the inorganic filler tends not to sufficiently proceed when the carbon black is dispersed in the dispersing solvent. Therefore, the amount of the inorganic filler added relative to the amount of the carbon black added is preferably adjusted to 5% by mass or more, and more preferably 10% by mass or more.

In the step (i), the method for dispersing carbon black in a dispersing solvent in the presence of an inorganic filler may be a method of dispersing the carbon black by using an ordinary dispersing machine such as a highly shearing mixer, a homomixer, a ball mill, a bead mill, a high-pressure homogenizer, an ultrasonic homogenizer, and a colloid mill. In particular, in the present invention, it is preferable, in the step (i), to disperse carbon black in a dispersing solvent in the presence of an inorganic filler by using a highly shearing mixer.

The “highly shearing mixer” means a mixer having a high-speed-rotatable rotor and a fixed stator in which the rotor is rotated with a precise clearance being made between the rotor and the stator, so that a highly shearing effect acts. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. One example thereof is “High Shear Mixer”, manufactured by SILVERSON.

### (2) Step (ii)

In the step (ii), a slurry-containing rubber latex solution is produced by mixing the slurry solution with a rubber latex solution. The method of mixing the slurry solution with the rubber latex solution in a liquid phase is not particularly limited, and examples thereof include a method of mixing the slurry solution with the rubber latex solution by using an ordinary dispersing machine such as a highly shearing mixer, a High Shear Mixer, a homomixer, a ball mill, a bead mill, a high-pressure homogenizer, an ultrasonic homogenizer, or a colloid mill, or a mixer in which a blade rotates in a cylindrical container. As required, at the time of the mixing, the whole of the mixing system, such as the dispersing machine, may be heated.

(3) Step (iii)

In the step (iii), the slurry-containing rubber latex solution is first solidified to produce a carbon black-containing rubber solidified product. Examples of the solidification method include a method of including a solidifier in a slurry-containing rubber latex solution. In this case, the solidifier may be one used ordinarily to solidify a rubber latex solution, such as an acid such as formic acid or sulfuric acid, or a salt such as sodium chloride. Subsequently, in the step (iii), the resulting carbon black-containing rubber solidified product is dehydrated and dried to finally produce a rubber wet masterbatch. As the method for dehydrating and drying the resulting carbon black-containing rubber solidified product, for example, the carbon black-containing rubber solidified product can be dehydrated and dried under the application of a shearing force to the product with heating to 100 to 250° C. by using a single screw extruder. Before the dehydration and drying, if necessary, for example, a solid-liquid separation step using centrifugation or a vibrating screen may be provided for the purpose of appropriately reducing the amount of water contained in the carbon black-containing rubber solidified product, or alternatively, a washing step such as a water washing method may be provided for the purpose of washing. In order to further dry the rubber wet masterbatch, various drying apparatuses such as an oven, a vacuum dryer, and an air dryer can be used.

After the step (iii), a rubber composition is produced by dry-mixing various rubber compounding ingredients with the resulting rubber wet masterbatch. Examples of usable rubber compounding ingredients include compounding ingredients usually used in the rubber industry such as sulfur-based vulcanizing agents, vulcanization accelerators, anti-aging agents, silica, silane coupling agents, zinc oxide, methylene receptors and methylene donors, stearic acid, vulcanization accelerating aids, vulcanization retardants, organic peroxides, softening agents such as waxes and oils, and processing aids.

The sulfur as the sulfur-based vulcanizing agent may be any ordinary sulfur for rubber, and for example, powdered sulfur, precipitated sulfur, insoluble sulfur, and highly dispersible sulfur can be used. The sulfur content in the rubber composition according to the present invention is preferably 0.3 to 6 parts by mass for 100 parts by mass of the rubber component. When the sulfur content is less than 0.3 parts by mass, the crosslinkage density of the vulcanized rubber is insufficient, and the rubber strength and the like are reduced. When it exceeds 6 parts by mass, both the heat resistance and the endurance are particularly deteriorated. In order to ensure good rubber strength of the vulcanized rubber and to further improve heat resistance and endurance, the sulfur content is more preferably 1.5 to 5.5 parts by mass, and even more preferably 2.0 to 4.5 parts by mass for 100 parts by mass of the rubber component.

As the vulcanization accelerator, vulcanization accelerators commonly used for rubber vulcanization, such as sulfenamide-based vulcanization accelerators, thiuram-based vulcanization accelerators, thiazole-based vulcanization accelerators, thiourea-based vulcanization accelerators, guanidine-based vulcanization accelerators, and dithiocarbamate-based vulcanization accelerators may be used singly or as an appropriate mixture. The content of the vulcanization accelerator is more preferably 1.0 to 5.0 parts by mass, and even more preferably 1.5 to 4.0 parts by mass for 100 parts by mass of the rubber component.

As the anti-aging agent, antioxidants that are commonly used for rubbers such as aromatic amine anti-aging agents, amine-ketone anti-aging agents, monophenol anti-aging agents, bisphenol anti-aging agents, polyphenol anti-aging agents, dithiocarbamic acid salt antioxidants, and thiourea antioxidants may be used singly or as an appropriate mixture. The content of the anti-aging agent is more preferably 0.5 to 6.0 parts by mass, and even more preferably 1.0 to 4.5 parts by mass for 100 parts by mass of the rubber component.

As described above, the rubber wet masterbatch obtained in step (iii) is superior in dispersibility of carbon black. For this reason, a pneumatic tire produced using a rubber composition comprising such a rubber wet masterbatch, specifically a pneumatic tire using a rubber composition according to the present invention in a tread rubber, a side rubber, a ply or belt coating rubber, or a bead filler rubber has a rubber region attaining, for example, the compatibility of performance to achieve reduced heat generation with performance to resist fatigue.

### Second Embodiment

Hereinafter, a method for producing a rubber member for pneumatic tires according to the present invention will be described. Such a production method is characterized by the process of producing the rubber wet masterbatch to be used as a raw material, and specifically, the rubber wet masterbatch is produced through the following (i) to (iii).

Step (i) of producing a slurry solution by dispersing carbon black in a dispersing solvent in the presence of an inorganic filler,

step (ii) of producing a slurry-containing rubber latex solution by mixing the slurry solution with a rubber latex solution, and

step (iii) of producing a rubber wet masterbatch by solidifying and drying the slurry-containing rubber latex solution.

### (1) Step (i)

In step (i), carbon black is dispersed in a dispersing solvent in the presence of an inorganic filler, and thus a slurry solution containing the inorganic filler and the carbon black is produced. As to the timing when the carbon black is added to the dispersing solvent, the carbon black may be added after the inorganic filler is added to the dispersing solvent in advance and, if necessary, the inorganic filler is dispersed in the dispersing solvent, or alternatively, the carbon black and the inorganic filler may be added simultaneously to the dispersing solvent. In the step (i), the concentration of the carbon black in the dispersing solvent may be appropriately adjusted in consideration of workability and the like, but it is preferably about 2 to 15% by mass in consideration of the dispersibility of the carbon black.

In the step (i), the amount of the inorganic filler added relative to the amount of the carbon black added is adjusted to less than 50% by mass. In order to produce a slurry solution in which carbon black is uniformly dispersed, it is more preferable to adjust the amount of the inorganic filler added relative to the amount of the carbon black added to be less than 45% by mass. When the amount of the inorganic filler added relative to the amount of the carbon black added is extremely small, the crush of the carbon black by the inorganic filler tends not to sufficiently proceed when the carbon black is dispersed in the dispersing solvent. Therefore, the amount of the inorganic filler added relative to the amount of the carbon black added is preferably adjusted to 5% by mass or more, and more preferably 10% by mass or more.

In the step (i), the method for dispersing carbon black in a dispersing solvent in the presence of an inorganic filler may be a method of dispersing the carbon black by using an ordinary dispersing machine such as a highly shearing mixer, a homomixer, a ball mill, a bead mill, a high-pressure homogenizer, an ultrasonic homogenizer, and a colloid mill. In particular, in the present invention, it is preferable, in the step (i), to disperse carbon black in a dispersing solvent in the presence of an inorganic filler by using a highly shearing mixer.

The “highly shearing mixer” means a mixer having a high-speed-rotatable rotor and a fixed stator in which the rotor is rotated with a precise clearance being made between the rotor and the stator, so that a highly shearing effect acts. In order to produce such a highly shearing effect, it is preferred to set the clearance between the rotor and the stator to 0.8 mm or less, and set the circumferential speed of the rotor to 5 m/s or more. Such a highly shearing mixer may be a commercially available product. One example thereof is “High Shear Mixer”, manufactured by SILVERSON.

### (2) Step (ii)

In the step (ii), a slurry-containing rubber latex solution is produced by mixing the slurry solution with a rubber latex solution. The method of mixing the slurry solution with the rubber latex solution in a liquid phase is not particularly limited, and examples thereof include a method of mixing the slurry solution with the rubber latex solution by using an ordinary dispersing machine such as a highly shearing mixer, a High Shear Mixer, a homomixer, a ball mill, a bead mill, a high-pressure homogenizer, an ultrasonic homogenizer, or a colloid mill, or a mixer in which a blade rotates in a cylindrical container. As required, at the time of the mixing, the whole of the mixing system, such as the dispersing machine, may be heated.

(3) Step (iii)

In the step (iii), the slurry-containing rubber latex solution is first solidified to produce a carbon black-containing rubber solidified product. Examples of the solidification method include a method of including a solidifier in a slurry-containing rubber latex solution. In this case, the solidifier may be one used ordinarily to solidify a rubber latex solution, such as an acid such as formic acid or sulfuric acid, or a salt such as sodium chloride. Subsequently, in the step (iii), the resulting carbon black-containing rubber solidified product is dehydrated and dried to finally produce a rubber wet masterbatch. As the method for dehydrating and drying the resulting carbon black-containing rubber solidified product, for example, the carbon black-containing rubber solidified product can be dehydrated and dried under the application of a shearing force to the product with heating to 100 to 250° C. by using a single screw extruder. Before the dehydration and drying, if necessary, for example, a solid-liquid separation step using centrifugation or a vibrating screen may be provided for the purpose of appropriately reducing the amount of water contained in the carbon black-containing rubber solidified product, or alternatively, a washing step such as a water washing method may be provided for the purpose of washing. In order to further dry the rubber wet masterbatch, various drying apparatuses such as an oven, a vacuum dryer, and an air dryer can be used.

After the step (iii), a rubber composition is produced by dry-mixing various rubber compounding ingredients with the resulting rubber wet masterbatch. Examples of usable rubber compounding ingredients include compounding ingredients usually used in the rubber industry such as sulfur-based vulcanizing agents, vulcanization accelerators, anti-aging agents, silica, silane coupling agents, zinc oxide, methylene receptors and methylene donors, stearic acid, vulcanization accelerating aids, vulcanization retardants, organic peroxides, softening agents such as waxes and oils, and processing aids.

The sulfur as the sulfur-based vulcanizing agent may be any ordinary sulfur for rubber, and for example, powdered sulfur, precipitated sulfur, insoluble sulfur, and highly dispersible sulfur can be used. The sulfur content in the rubber composition according to the present invention is preferably 0.3 to 6 parts by mass for 100 parts by mass of the rubber component. When the sulfur content is less than 0.3 parts by mass, the crosslinkage density of the vulcanized rubber is insufficient, and the rubber strength and the like are reduced. When it exceeds 6 parts by mass, both the heat resistance and the endurance are particularly deteriorated. In order to ensure good rubber strength of the vulcanized rubber and to further improve heat resistance and endurance, the sulfur content is more preferably 1.5 to 5.5 parts by mass, and even more preferably 2.0 to 4.5 parts by mass for 100 parts by mass of the rubber component.

As the vulcanization accelerator, vulcanization accelerators commonly used for rubber vulcanization, such as sulfenamide-based vulcanization accelerators, thiuram-based vulcanization accelerators, thiazole-based vulcanization accelerators, thiourea-based vulcanization accelerators, guanidine-based vulcanization accelerators, and dithiocarbamate-based vulcanization accelerators may be used singly or as an appropriate mixture. The content of the vulcanization accelerator is more preferably 1.0 to 5.0 parts by mass, and even more preferably 1.5 to 4.0 parts by mass for 100 parts by mass of the rubber component.

As the anti-aging agent, antioxidants that are commonly used for rubbers such as aromatic amine anti-aging agents, amine-ketone anti-aging agents, monophenol anti-aging agents, bisphenol anti-aging agents, polyphenol anti-aging agents, dithiocarbamic acid salt antioxidants, and thiourea antioxidants may be used singly or as an appropriate mixture. The content of the anti-aging agent is more preferably 0.5 to 6.0 parts by mass, and even more preferably 1.0 to 4.5 parts by mass for 100 parts by mass of the rubber component.

As described above, the rubber wet masterbatch obtained in step (iii) is superior in dispersibility of carbon black. For this reason, a pneumatic tire produced using a rubber composition comprising such a rubber wet masterbatch, specifically a pneumatic tire using a rubber composition according to the present invention in a tread rubber, a side rubber, a ply or belt coating rubber, or a bead filler rubber has a rubber member attaining, for example, the compatibility of ability to achieve reduced heat generation with reinforceability. The rubber member described above can be produced by using a rubber composition comprising the rubber wet masterbatch obtained in the step (iii) and molding the rubber composition by a method known to those skilled in the art. Further, a pneumatic tire can be produced by producing a green tire by combining unvulcanized rubber members individually produced and then appropriately subjecting the green tire to vulcanization molding. Since the rubber members constituting such a pneumatic tire are superior in ability to achieve reduced heat generation and reinforceability, the pneumatic tire is also superior in ability to achieve reduced heat generation and reinforceability.

### EXAMPLES

### First Embodiment

Hereinafter, the present invention will be more specifically described by demonstrating working examples thereof.

### (Raw Materials Used)

a) Carbon black

Carbon black “N134”; “SEAST 9H” (manufactured by Tokai Carbon Co., Ltd.)

Carbon black “N234”; “SEAST 7HM” (manufactured by Tokai Carbon Co., Ltd.)

Carbon black “N339”: “SEAST KH” (manufactured by Tokai Carbon Co., Ltd.)

Carbon black “N550”; “SEAST SO” (manufactured by Tokai Carbon Co., Ltd.)

b) Inorganic filler

Silica 1; “Ultrasil 7000GR” (manufactured by Evonik Industries AG), Mohs hardness: 7, BET specific surface area: 170 m²/g

Silica 2; “Ultrasil9100GR” (manufactured by Evonik Industries AG), Mohs hardness: 7, BET specific surface area: 235 m²/g

Alumina; “AS-50” (manufactured by Showa Denko K.K.), Mohs hardness: 9

c) Dispersing solvent: water

d) Rubber latex solution

Natural rubber latex solution (NR field latex); (manufactured by Golden Hope) (a product with DRC=31.2% was adjusted such that the rubber concentration was 25% by mass.)

e) Solidifier: formic acid (a product prepared by diluting a primary grade 85%, 10% solution to have pH 1.2); “manufactured by Nacalai Tesque, Inc.”

f) Zinc flower: Zinc flower No. 1 (manufactured by Mitsui Mining & Smelting Co., Ltd.)

g) Stearic acid; “LUNAC S-20”, (manufactured by Kao Corporation)

h) Wax; “OZOACE0355”, (manufactured by Nippon Seiro Co., Ltd.)

i) Anti-aging agent

(A) N-phenyl-N′-(1,3-dimethylbutyl)-p-phenylenediamine “6C” (manufactured by Ouchi Shinko Chemical Industrial Co., Ltd.)

(B) 2,2,4-trimethyl-1,2-dihydroquinoline polymer “RD” (manufactured by Ouchi Shinko Chemical Industrial Co., Ltd.)

j) Sulfur, (manufactured by Tsurumi Chemical Industry Co., Ltd.)

k) Vulcanization accelerator

N-Cyclohexyl-2-benzothiazole sulfenamide; “SANCELER CM”, (manufactured by Sanshin Chemical Industry Co., Ltd.)

### Examples 1 to 8

Carbon black and an inorganic filler in the amounts shown in Table 1 were added simultaneously to water as a dispersing solvent, and then the carbon black was dispersed using a powder/liquid mixing system (FLASHBLEND) manufactured by SILVERSON Machines Ltd., which was a highly shearing mixer (the condition of the FLASHBLEND: 3600 rpm, 30 minutes), whereby a slurry solution comprising the carbon black and the inorganic filler was produced (step (i)). A natural rubber latex solution in the amount in solid content shown in Table 1 was added to the resulting slurry solution and mixed using a mixer manufactured by Kawata Manufacturing Co., Ltd. (Supermixer SM-20) (mixer conditions: 1000 rpm, 30 minutes) to produce a slurry-containing natural rubber latex solution (step (ii)).

Formic acid as a solidifier was added to the slurry-containing natural rubber latex solution produced in step (ii) until the entire solution reached pH 4 to produce a carbon black-containing natural rubber solidified product. The resulting carbon black-containing natural rubber solidified product was subjected to a solid-liquid separation step, then charged into a screw press V-02 manufactured by SUEHIRO EPM Corporation, and dried to produce a rubber wet masterbatch (step (iii)). The compounding ratios shown in Table 1 are expressed by parts by mass (phr) where the total amount of the rubber component (solid component) in the natural rubber latex solution is 100 parts by mass.

Various rubber compounding ingredients shown in Table 1 were added to the resulting rubber wet masterbatch, and dry-mixed using a Banbury mixer to produce a rubber composition. The mixing ratios in Table 1 are shown in parts by mass (phr) when the total amount of the rubber component (solid content) in the natural rubber latex solution is 100 parts by mass.

### Comparative Examples 1 to 5

In Comparative Examples 1, 3, 4, and 5, instead of producing a rubber wet masterbatch, rubber compositions were produced by adding natural rubber (RSS #3), carbon black, silica and various rubber compounding ingredients shown in Table 1 were added, and then dry-mixed. In Comparative Example 2, a rubber wet masterbatch and a rubber composition were produced in the same manner as in Examples 1 to 5, except that in the step (i), the amount of silica added to carbon black was changed.

### (Evaluation)

The evaluation was performed for the rubber obtained by heating and vulcanizing each rubber composition at 150° C. for 30 minutes using a prescribed mold.

### (Dispersibility of Carbon Black)

In accordance with ISO 11345, the degree of dispersion of carbon black in a vulcanized rubber was measured. The evaluations of Examples 1 to 5 and Comparative Example 2 are expressed by index evaluations with the degree of dispersion of Comparative Example 1 being regarded as 100, and similarly, the evaluations of Examples 6, 7, and 8 are expressed by index evaluations with the degrees of dispersion of Comparative Examples 3, 4, and 5 being regarded as 100, respectively. The higher the numerical value, the better the dispersibility of carbon black in a finally obtained vulcanized rubber, and therefore, the better in the dispersibility of carbon black in a rubber wet masterbatch and a rubber composition, which will serve as raw materials.

TABLE 1

| | | | | Comparative | Comparative | Example | Example | Example | Example | Example |
|---|---|---|---|---|---|---|---|---|---|---|
| | | | | Example 1 | Example 2 | 1 | 2 | 3 | A | 5 |
| Rubber | Rubber wet | Inorganic | Silica 1 | — | 25 | 5 | — | — | 10 | 15 |
| composition | masterbatch | filler | Silica 2 | — | — | — | 5 | — | — | — |
| formulation | components | | Alumina | — | — | — | — | 5 | — | — |
| (parts by | | Carbon | N134 | — | — | — | — | — | — | — |
| mass) | | black | N234 | — | 25 | 45 | 45 | 45 | 40 | 35 |
| | | | N339 | — | — | — | — | — | — | — |
| | | | N550 | — | — | — | — | — | — | — |
| | | Natural rubber (solid) | | — | — | 100 | 100 | 100 | 100 | 100 |
| | Dry mixing | Inorganic | Silica 1 | 5 | — | — | — | — | — | — |
| | components | filler | | | | | | | | |
| | | Carbon | N134 | — | — | — | — | — | — | — |
| | | black | N234 | 45 | — | — | — | — | — | — |
| | | | N339 | — | — | — | — | — | — | — |
| | | | N550 | — | — | — | — | — | — | — |

| | | | | | | | |
|---|---|---|---|---|---|---|---|
| Natural rubber (solid) | 100 | — | — | — | — | — | — |
| Zinc flower | 3 | — | 3 | 3 | 3 | 3 | 3 |
| Stearic acid | 2 | — | 2 | 2 | 2 | 2 | 2 |
| Wax | 1 | — | 1 | 1 | 1 | 1 | 1 |
| Anti-aging agent A | 2 | — | 2 | 2 | 2 | 2 | 2 |
| Anti-aging agent B | 1 | — | 1 | 1 | 1 | 1 | 1 |
| Sulfur | 2 | — | 2 | 2 | 2 | 2 | 2 |
| Vulcanization | 1 | — | 1 | 1 | 1 | 1 | 1 |
| accelerator | | | | | | | |

| | | | | | | | | |
|---|---|---|---|---|---|---|---|---|
| Vulcanized | Carbon black dispersion (INDEX) | 100 | Not | 111 | 113 | 105 | 115 | 120 |
| rubber | | | evaluated | | | | | |

TABLE 2

| | | | | Comparative | | Comparative | | Comparative | |
|---|---|---|---|---|---|---|---|---|---|
| | | | | Example 3 | Example 6 | Example 4 | Example 7 | Example 5 | Example 8 |
| Rubber | Rubber wet | Inorganic | Silica 1 | — | 5 | — | 5 | — | 5 |
| composition | masterbatch | filler | Silica 2 | — | — | — | — | — | — |
| formulation | components | | Alumina | — | — | — | — | — | — |
| (parts by | | Carbon | N134 | — | 45 | — | — | — | — |
| mass) | | black | N234 | — | — | — | — | — | — |
| | | | N339 | — | — | — | 45 | — | — |
| | | | N550 | — | — | — | — | — | 45 |
| | | Natural rubber (solid) | | — | 100 | — | — | — | — |
| | Dry mixing | Inorganic | Silica 1 | 5 | — | 5 | — | 5 | — |
| | components | filler | | | | | | | |
| | | Carbon | N134 | 45 | — | — | — | — | — |
| | | black | N234 | — | — | — | — | — | — |
| | | | N339 | — | — | 45 | — | — | — |
| | | | N550 | — | — | — | — | 45 | — |

| | | | | | | |
|---|---|---|---|---|---|---|
| Natural rubber (solid) | 100 | — | 100 | — | 100 | — |
| Zinc flower | 3 | 3 | 3 | 3 | 3 | 3 |
| Stearic acid | 2 | 2 | 2 | 2 | 2 | 2 |
| Wax | 1 | 1 | 1 | 1 | 1 | 1 |
| Anti-aging agent A | 2 | 2 | 2 | 2 | 2 | 2 |
| Anti-aging agent B | 1 | 1 | 1 | 1 | 1 | 1 |
| Sulfur | 2 | 2 | 2 | 2 | 2 | 2 |
| Vulcanization | 1 | 1 | 1 | 1 | 1 | 1 |
| accelerator | | | | | | |

| | | | | | | | |
|---|---|---|---|---|---|---|---|
| Vulcanized | Carbon black dispersion (INDEX) | 100 | 110 | 100 | 108 | 100 | 107 |
| rubber | | | | | | | |

The results shown in Tables 1 and 2 reveal that by virtue of the superior dispersibility of the carbon black in the rubber wet masterbatches produced in Examples 1 to 8, the dispersibility of the carbon black in the finally obtained vulcanized rubbers was also improved. In Comparative Example 2, since the amount of silica added in the step (i) was excessively large, a uniform slurry solution was not produced, and as a result, a rubber wet masterbatch could not be produced.

### Second Embodiment

Hereinafter, the present invention will be more specifically described by demonstrating working examples thereof.

### (Raw Materials Used)

a) Carbon black

Carbon black “N134”; “SEAST 9H” (manufactured by Tokai Carbon Co., Ltd.)

Carbon black “N234”; “SEAST 7HM” (manufactured by Tokai Carbon Co., Ltd.)

Carbon black “N339”: “SEAST KH” (manufactured by Tokai Carbon Co., Ltd.)

b) Inorganic filler

Silica 1; “Ultrasil 7000GR” (manufactured by Evonik Industries AG), Mohs hardness: 7, BET specific surface area: 170 m²/g

Silica 2; “Ultrasil9100GR” (manufactured by Evonik Industries AG), Mohs hardness: 7, BET specific surface area: 235 m²/g

Alumina; “AS-50” (manufactured by Showa Denko K.K.), Mohs hardness: 9

c) Dispersing solvent: water

d) Rubber latex solution

Natural rubber latex solution (NR field latex); (manufactured by Golden Hope) (a product with DRC=31.2% was adjusted such that the rubber concentration was 25% by mass.)

e) Solidifier: formic acid (a product prepared by diluting a primary grade 85%, 10% solution to have pH 1.2); “manufactured by Nacalai Tesque, Inc.”

f) Synthetic rubber; “BR150L”, (manufactured by Ube Industries, Ltd.)

g) Zinc flower: Zinc flower No. 1 (manufactured by Mitsui Mining & Smelting Co., Ltd.)

h) Stearic acid; “LUNAC S-20”, (manufactured by Kao Corporation)

i) Wax; “OZOACE 0355”, (manufactured by Nippon Seiro Co., Ltd.)

j) Anti-aging agent

(A) N-Phenyl-N′-(1,3-dimethylbutyl)-p-phenylenediamine “NOCRAC 6C”, (manufactured by Ouchi Shinko Chemical Industrial Co., Ltd.)

(B) 2,2,4-Trimethyl-1,2-dihydroquinoline polymer “NOCRAC RD”, (manufactured by Ouchi Shinko Chemical Industrial Co., Ltd.)

k) Silane coupling agent; “Si69”, (manufactured by Evonik Industries AG)

l) Sulfur, (manufactured by Tsurumi Chemical Industry Co., Ltd.)

m) Vulcanization accelerator

N-Cyclohexyl-2-benzothiazole sulfenamide; “SANCELER CM”, (manufactured by Sanshin Chemical Industry Co., Ltd.)

### Examples 9 to 15

Carbon black and an inorganic filler in the amounts shown in Table 3 were added simultaneously to water as a dispersing solvent, and then the carbon black was dispersed using a powder/liquid mixing system (FLASHBLEND) manufactured by SILVERSON Machines Ltd., which was a highly shearing mixer (the condition of the FLASHBLEND: 3600 rpm, 30 minutes), whereby a slurry solution comprising the carbon black and the inorganic filler was produced (step (i)). A natural rubber latex solution in the amount in solid content shown in Table 3 was added to the resulting slurry solution and mixed using a mixer manufactured by Kawata Manufacturing Co., Ltd. (Supermixer SM-20) (mixer conditions: 1000 rpm, 30 minutes) to produce a slurry-containing natural rubber latex solution (step (ii)).

Formic acid as a solidifier was added to the slurry-containing natural rubber latex solution produced in step (ii) until the entire solution reached pH 4 to produce a carbon black-containing natural rubber solidified product. The resulting carbon black-containing natural rubber solidified product was subjected to a solid-liquid separation step, then charged into a screw press V-02 manufactured by SUEHIRO EPM Corporation, and dried to produce a rubber wet masterbatch (step (iii)). The compounding ratios shown in Table 3 are expressed by parts by mass (phr) where the total amount of the rubber component (solid component) in the natural rubber latex solution is 100 parts by mass.

Various rubber compounding ingredients shown in Table 3 were added to the resulting rubber wet masterbatch, and dry-mixed using a Banbury mixer to produce a rubber composition. The mixing ratios in Table 3 are shown in parts by mass (phr) when the total amount of the rubber component (solid content) in the natural rubber latex solution is 100 parts by mass.

### Example 16

A rubber composition was produced by producing a rubber wet masterbatch by use of 80 parts by mass of a natural rubber (solid) in a rubber wet masterbatch production stage, adding various rubber compounding ingredients, adding 20 parts by mass of a synthetic resin when dry-mixing by using a Banbury mixer, and performing dry-mixing.

### Comparative Examples 6 to 9

In Comparative Examples 6, 7, and 8, instead of producing a rubber wet masterbatch, rubber compositions were produced by adding natural rubber (RSS #3), carbon black, silica and various rubber compounding ingredients shown in Table 3 were added, and then dry-mixed. In Comparative Example 9, instead of producing a rubber wet masterbatch, a rubber composition was produced by adding natural rubber (RSS #3), a natural rubber, carbon black, silica and various rubber compounding ingredients shown in Table 3 were added, and then dry-mixed.

(Evaluation)

The evaluation was performed for the rubber obtained by heating and vulcanizing each rubber composition at 150° C. for 30 minutes using a prescribed mold.

### (Ability to Achieve Reduced Heat Generation)

Using a viscoelasticity tester manufactured by Toyo Seiki Seisaku-sho, Ltd., the loss coefficient tan 6 was measured under the conditions defined by an initial strain of 10%, a dynamic strain of 1%, a frequency of 10 Hz, and a temperature of 60° C. The evaluations of Examples 9 to 13 are expressed by an index evaluation with the tan 5 of Comparative Example 6 being regarded as 100, and similarly, the evaluations of Examples 14, 15, and 16 are expressed by index evaluations with the tan 5 of Comparative Examples 7, 8, and 9 being regarded as 100, respectively. The lower the numerical value, the better the dispersibility of the carbon black in the rubber member, and therefore the better the ability to achieve reduced heat generation.

### (Reinforceability)

A sample prepared using a JIS No. 3 dumbbell was examined in accordance with JIS-K 6251. The (breaking strength) (MPa) and the (elongation at break) (%) of a resulting vulcanized rubber were measured. From the measured values, a (tensile product) determined by (breaking strength)×(elongation at break) was calculated. The evaluations of Examples 9 to 13 are expressed by an index evaluation with the tensile product of Comparative Example 1 being regarded as 100, and similarly, the evaluations of Examples 6, 7, and 8 are expressed by index evaluations with the tensile products of Comparative Examples 7, 8, and 9 being regarded as 100, respectively. The higher the numerical value, the better the dispersibility of the carbon black in the rubber member, and therefore the better the reinforceability.

TABLE 3

| | | | | Comparative | | | | | |
|---|---|---|---|---|---|---|---|---|---|
| | | | | Example 6 | Example 9 | Example 10 | Example 11 | Example 12 | Example 13 |
| Rubber | Rubber wet | Inorganic | Silica 1 | — | 5 | — | — | 10 | 20 |
| composition | masterbatch | filler | Silica 2 | — | — | 5 | — | — | — |
| formulation | components | | Alumina | — | — | — | 5 | — | — |
| (parts by | | Carbon | N134 | — | 45 | 45 | 45 | 40 | 30 |
| mass) | | black | N234 | — | — | — | — | — | — |
| | | | N339 | — | — | — | — | — | — |
| | | Natural rubber (solid) | | — | 100 | 100 | 100 | 100 | 100 |
| | Dry mixing | Inorganic | Silica 1 | 5 | — | — | — | — | — |
| | components | filler | | | | | | | |
| | | Carbon | N134 | 45 | — | — | — | — | — |
| | | black | N234 | — | — | — | — | — | — |
| | | | N339 | — | — | — | — | — | — |

| | | | | | | |
|---|---|---|---|---|---|---|
| Natural rubber (solid) | 100 | — | — | — | — | — |
| Synthetic rubber (solid) | — | — | — | — | — | — |
| Zinc flower | 3 | 3 | 3 | 3 | 3 | 3 |
| Stearic acid | 2 | 2 | 2 | 2 | 2 | 2 |
| Wax | 1 | 1 | 1 | 1 | 1 | 1 |
| Anti-aging agent A | 2 | 2 | 2 | 2 | 2 | 2 |
| Anti-aging agent B | 1 | 1 | 1 | 1 | 1 | 1 |
| Silane coupling agent | — | — | — | — | — | 2 |
| Sulfur | 2 | 2 | 2 | 2 | 2 | 2 |
| Vulcanization | 1 | 1 | 1 | 1 | 1 | 1 |
| accelerator | | | | | | |

| | | | | | | | |
|---|---|---|---|---|---|---|---|
| Vulcanized | Ability to achieve reduced heat | 100 | 93 | 94 | 95 | 88 | 74 |
| rubber | generation | | | | | | |
| | Reinforceability | 100 | 108 | 108 | 106 | 110 | 109 |

TABLE 4

| | | | | Comparative | | Comparative | | Comparative | |
|---|---|---|---|---|---|---|---|---|---|
| | | | | Example 7 | Example 14 | Example 8 | Example 15 | Example 9 | Example 16 |
| Rubber | Rubber wet | Inorganic | Silica 1 | — | 5 | — | 10 | — | 5 |
| composition | masterbatch | filler | Silica 2 | — | — | — | — | — | — |
| formulation | components | | Alumina | — | — | — | — | — | — |
| (parts by | | Carbon | N134 | — | — | — | | — | 35 |
| mass) | | black | N234 | — | 45 | — | 30 | — | — |
| | | | N339 | — | — | — | 15 | — | — |
| | | Natural rubber (solid) | | — | 100 | — | 100 | — | 80 |
| | Dry mixing | Inorganic | Silica 1 | 5 | — | 10 | — | 5 | — |
| | components | filler | | | | | | | |
| | | Carbon | N134 | — | — | — | — | 45 | 10 |
| | | black | N234 | 45 | — | 30 | — | — | — |
| | | | N339 | — | — | 15 | — | — | — |

| | | | | | | |
|---|---|---|---|---|---|---|
| Natural rubber (solid) | 100 | — | 100 | — | 80 | — |
| Synthetic rubber (solid) | — | — | — | — | 20 | 20 |
| Zinc flower | 3 | 3 | 3 | 3 | 3 | 3 |
| Stearic acid | 2 | 2 | 2 | 2 | 2 | 2 |
| Wax | 1 | 1 | 1 | 1 | 1 | 1 |
| Anti-aging agent A | 2 | 2 | 2 | 2 | 2 | 2 |
| Anti-aging agent B | 1 | 1 | 1 | 1 | 1 | 1 |
| Silane coupling agent | — | — | — | — | — | — |
| Sulfur | 2 | 2 | 2 | 2 | 2 | 2 |
| Vulcanization | 1 | 1 | 1 | 1 | 1 | 1 |
| accelerator | | | | | | |

| | | | | | | | |
|---|---|---|---|---|---|---|---|
| Vulcanized | Ability to achieve reduced heat | 100 | 94 | 100 | 94 | 100 | 74 |
| rubber | generation | | | | | | |
| | Reinforceability | 100 | 106 | 100 | 104 | 100 | 110 |

The results shown in Tables 3 and 4 reveal that by virtue of the superior dispersibility of the carbon black in the rubber wet masterbatches produced in Examples 9 to 16, the dispersibility of the carbon black in the finally obtained vulcanized rubbers (rubber members) was also improved.

1-6. (canceled)

7. A method for producing a rubber wet masterbatch comprising step (i) of producing a slurry solution by dispersing carbon black in a dispersing solvent in the presence of an inorganic filler, step (ii) of producing a slurry-containing rubber latex solution by mixing the slurry solution with a rubber latex solution, and step (iii) of producing a rubber wet masterbatch by solidifying and drying the slurry-containing rubber latex solution, wherein
the inorganic filler has a Mohs hardness of 5 or more, and
in the step (i), the amount of the inorganic filler added is less than 50% by mass where the amount of the carbon black added is 100% by mass.

8. The method for producing a rubber wet masterbatch according to claim 7, wherein the step (i) is a step of dispersing the carbon black in the dispersing solvent using a highly shearing mixer.

9. The method for producing a rubber wet masterbatch according to claim 7, wherein the inorganic filler is silica.

10. The method for producing a rubber wet masterbatch according to claim 7, wherein the inorganic filler is alumina.

11. The method for producing a rubber wet masterbatch according to claim 7, wherein the loading of the inorganic filler is 1 to 40 parts by mass where the total amount of the rubber component in the rubber composition obtained from the rubber wet masterbatch as a raw material is 100 parts by mass.

12. A method for producing a rubber member for pneumatic tires obtained by vulcanizing a rubber composition comprising at least a rubber wet masterbatch, wherein
the rubber wet masterbatch is produced through the following steps (i) to (iii);
step (i): a step of producing a slurry solution by dispersing carbon black in a dispersing solvent in the presence of an inorganic filler
step (ii): a step of producing a slurry-containing rubber latex solution by mixing the slurry solution with a rubber latex solution
step (iii): a step of producing a rubber wet masterbatch by solidifying and drying the slurry-containing rubber latex solution, wherein
the inorganic filler has a Mohs hardness of 5 or more, and in the step (i), the amount of the inorganic filler added is less than 50% by mass where the amount of the carbon black added is 100% by mass.

13. The method for producing a rubber member for pneumatic tires according to claim 12, wherein the step (i) is a step of dispersing the carbon black in the dispersing solvent using a highly shearing mixer.

14. The method for producing a rubber wet masterbatch according to claim 12, wherein the inorganic filler is silica.

15. The method for producing a rubber wet masterbatch according to claim 12, wherein the inorganic filler is alumina.

16. The method for producing a rubber wet masterbatch according to claim 12, wherein the loading of the inorganic filler is 1 to 40 parts by mass where the total amount of the rubber component in the rubber composition obtained from the rubber wet masterbatch as a raw material is 100 parts by mass.

17. The method for producing a rubber member for pneumatic tires according to claim 12, wherein the rubber member is a tread member.

18. A method for producing a pneumatic tire comprising a rubber member, wherein
the rubber member is produced by the production method according to claim 12.
